(19) United States
(12) Patent Application Publication
(10) Pub. No.: US 2019/0281764 A1
(43) Pub. Date: Sep. 19, 2019

(54) BERRY HARVESTER

(71) Applicant: Oxbo International Corporation, Byron, NY (US)

(72) Inventors: Kevin ROBERTS, Lynden, WA (US); Scott KORTHUIS, Lynden, WA (US); Michael TERBEEK, Lynden, WA (US); Matthew KORTHUIS, Lynden, WA (US)

(21) Appl. No.: 16/005,393

(22) Filed: Jun. 11, 2018

Related U.S. Application Data
(60) Provisional application No. 62/642,460, filed on Mar. 13, 2018.

(51) Int. Cl. A01D 46/26

(52) U.S. Cl. CPC A01D 46/264; A01D 2046/266

(57) ABSTRACT

A berry harvester provides flexible cushioned elements and surfaces to limit bruising of the fruit harvested. A chassis defines a picking tunnel that passes over rows of plants. A picking system removes fruit from the plants as the harvester moves along the rows. A catching system configured to receive fruit removed from the plants. The catching system includes resilient catch assemblies on each side of the picking tunnel, each of the catch assemblies at least partially overlapping adjacent catch assemblies. Each of the catch assemblies has an upper surface oriented orthogonally to horizontal and flex upon impact by falling fruit.

### BACKGROUND OF THE INVENTION

### Field of the Invention

The present invention is directed to a berry harvester and in particular to a berry harvester that provides flexible cushioned elements and surfaces to limit bruising of the fruit harvested.

### Description of the Prior Art

Berry harvesters such as mechanical blueberry harvesters are widely used for harvesting berries. Such harvesters are widely successful for harvesting berries for the processed market in which berries may be frozen or processed into other forms and used in other fruit products other than fresh berries.

Blueberries that are sold directly to the public as whole, fresh berries may be manually harvested. Although such harvesting protects the fruit and limits damage such as bruising or squashed berries, the process is highly labor intensive and expensive. Moreover, there may be problems with finding sufficient labor to harvest all of the fruit through a short window of time when the fruit is sufficiently ripe and before the fruit is too ripe.

It would generally be desirable to be able to consistently harvest fresh market quality berries with mechanical harvesters. As over half of the world's production of blueberries is non-processed and sold through fresh markets, there is ample demand for greater harvesting capacity of such fruit. Although mechanical harvesters have a much higher capacity and can harvest much faster than manual harvesting, they suffer from several problems that has limited their use for non-processed fresh market fruit. Mechanical harvesters may tend to bruise the fruit when the fruit is picked from the plant and transported to a storage container such as a lug or flat. At each time when a berry is dropped on a hard surface, macro bruising and micro bruising occurs. Although such bruising does not affect the quality of the processed berries, if the berries are harvested for the fresh market, such bruising can cause mold and fruit softening over a period of a few weeks. It can be appreciated that for berries that are harvested in South America for example and transported by ship to a market in North America, such a delay before arriving at market may occur. Therefore, mechanically harvested fruit has generally been considered to be inferior to the manually harvested fruit and has not been accepted as a fresh market quality product.

However, if the damage from being dropped were minimized or eliminated, mechanically harvested fruit would be acceptable as a fresh market quality product. Studies have indicated that fruit dropped on a hard surface covered with a foam substrate minimizes bruising, but if dropped more than 30-40 cm, bruising will still occur. However, if blueberries are dropped on a soft, padded surface or on a sheet that is not supported on the back side to allow flexing, such as with a trampoline type configuration, fruit dropped at over 1 meter is considered to be equivalent to manually harvested fruit. It can be appreciated that there are several areas in a mechanical fruit harvester that in which a drop occurs and which may be damaged. In particular, this may occur as the fruit is removed from the plants. To overcome such damage and eliminate hard surfaces, a system has been developed as shown in U.S. Pat. No. 9,750,188 to provide a soft surface. It can be appreciated that the catch plates in this system are constructed in a manner than may still cause damage to the fruit as the fruit must roll off the catcher soft surface and an edge created by the upper hoop tends to slice the fruit.

It can therefore be seen that a system and method for mechanically harvesting fruit such as blueberries are needed that eliminates macro and micro bruising due to dropping. Such a system should provide for surfaces that are flexible and cushioned and/or flex and eliminate hard surfaces that may cause bruising when berries are dropped on them. Moreover, such elements should eliminate a lip that may slice the fruit and should also have structural integrity and be lightweight and easy to replace should damage occur. The present invention addresses these as well as other problems associated with mechanical berry harvesters.

### SUMMARY OF THE INVENTION

The present invention is directed to a berry harvester having a fruit catching and transport system that has soft surfaces that lessen impact and damage to fruit. Over the row berry harvesters have a chassis that defines a picking tunnel through which plants pass as the harvester moves along a row of plants, such as blueberry bushes. The harvester includes a picking assembly, such as rotary picking heads having orbital shaking picking battens or other systems that engage the branches and dislodge fruit. It has been found that such agitation/engagement with the plants is effective in removing ripe berries. It can be appreciated however that the present invention is also adaptable to harvesters with other types of picking systems such as rotary picking heads with horizontally shaking picking battens, vertical shaking picking batten, or sway shaker systems that engage the plant canopy and shake the plant. The picking assembly of over the row harvesters is generally configured with the picking heads opposed on either side of the picking tunnel. As the harvester advances along the row of plants, the plants pass through the tunnel and are engaged by the picking assembly.

The fruit removed by the picking assembly falls onto a catching system. The catching system includes overlapping catching elements on either side of the picking tunnel. The catching elements are generally configured as catch plates that pivotally mount and are biased towards an extended position. However, the rotational mounting allows the plates to rotate or pivot backwards and around the canes or shoots of the berry bushes as the harvester advances. The catch plate generally pivots out of the way when engaging the crown, a collection of canes or shots of the plants and then is biased backward to an overlapping position. Moreover, the plates extend inward from a lower portion at each side of the picking tunnel and are also angled slightly upward toward the center to form a peak where the plates from each side overlap in the center of the tunnel. In this manner, fruit that falls under the catch plates rolls outward in the tunnel onto conveyors. The conveyors then transport the fruit to the filling station and may include additional conveyors or fans and/or a cleaning station to remove debris away from the harvested berries.

The picking tunnel includes surfaces that are composed of a soft padded material such as neoprene. The flexible cushioned surfaces therefore provide a soft engagement surface for fruit that is strewn against the surfaces. The soft neoprene surfaces reduce the impact from the fruit engaging the surfaces and therefore reduce bruising of the fruit.

It can also be appreciated that in addition to the hardness of the surface engaged by the dislodged fruit, the angle of impact may also lessen the force from the fruit striking surfaces. The lower portion of the picking tunnel may include angled receiving devices. The angled surface devices include a first upper sloped surface and/or second sloped surface. The upper surfaces and are made of a flexible trampoline type element having material that is stretched across rollers. The rollers are adjustable to tighten or loosen the upper surface layer and therefore adjust the elasticity of the surfaces. Moreover, an adjustment assembly provides for changing the slope of the upper angled surfaces and to optimize the receiving position of the surfaces and to minimize damage to the fruit.

It can further be appreciated that the catch plates for the catching system also may include surfaces that lessen the impact and therefore the damage to the fruit. A first embodiment of the catch plate includes a frame and a sheet stretched across the frame. The frame defines central openings and connects to a mounting portion that provides for rotation or pivoting. It can be appreciated that the upper surface of the catching element is slightly off from perpendicular to the axis of the mounting portion so that the catching elements form sloped surfaces that facilitate fruit rolling onto the conveyors. Moreover, the catching elements are configured so that they may slightly nest and overlap one another, both along the center line and from front to rear over adjacent catching elements. The sheet is attached by mounting elements such as screws, hooks or snaps. The center openings allow the material to flex slightly in a trampoline type manner to provide elasticity so the sheet flexes when struck by falling fruit. With such a mounting arrangement, the sheet is stretched so that there is resiliency, but also sufficient tautness to allow fruit to roll off the catching element while at the same time providing a cushioning effect by flexing or stretching from the fruit falling to lessen the impact. It can be appreciated that the shape may be varied somewhat as long as the upper surface lessens the damage from impact and provides overlap while directing fruit to roll toward the conveyors.

It can be appreciated that a flexible trampoline type catching sheet may take on multiple different configurations of a frame and a sheet stretched across the frame. The frame may have a different profile with a center opening or multiple openings and a ring at the edges of the sheet with a clamping configuration. The sheet may be mounted so as to be replaceable should it tear or be ruined. However, the configuration should be devoid of edges or other structures that may cut or squash the fruit.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

Referring now to the drawings, wherein like reference letters and numerals indicate corresponding structure throughout the several views:

FIG. 1 is a perspective view of a berry harvester according to the principles of the present invention;

FIG. 2 is a front elevational view of the berry harvester shown in FIG. 1;

FIG. 3 is a side elevational view of the berry harvester shown in FIG. 1;

FIG. 4 is a sectional view showing the left side of the berry harvester shown in FIG. 1;

FIG. 5 is a perspective view of the right side of the berry harvester shown in FIG. 1;

FIG. 6 is a bottom plan view of the berry harvester shown in FIG. 1;

FIG. 7 is a top perspective view of a first embodiment of a catch plate assembly for the berry harvester shown in FIG. 1;

FIG. 8 is a sectional view of the catch plate assembly shown in FIG. 7;

FIG. 9 is a perspective view of a second embodiment of a catch plate assembly for the berry harvester shown in FIG. 1;

FIG. 10 is a sectional view of the catch plate assembly shown in FIG. 9;

FIG. 11 is a perspective view of a third embodiment of a catch plate assembly for the berry harvester shown in FIG. 1;

FIG. 12 is a sectional view of the catch plate assembly shown in FIG. 11;

FIG. 13 is a perspective view of a fourth embodiment of a catch plate assembly for the berry harvester shown in FIG. 1;

FIG. 14 is a side sectional view of the catch plate assembly shown in FIG. 13;

FIG. 15 is a perspective view of a fifth embodiment of a catch plate assembly for the berry harvester shown in FIG. 1;

FIG. 16 is a sectional view of the catch plate assembly shown in FIG. 15;

FIG. 17 is a perspective view of a sixth embodiment of a catch plate assembly for the berry harvester shown in FIG. 1;

FIG. 18 is a bottom perspective view of the catch plate assembly shown in FIG. 17;

FIG. 19 is a perspective view of a seventh embodiment of a catch plate assembly for the berry harvester shown in FIG. 1;

FIG. 20 is a bottom perspective view of the catch plate assembly shown in FIG. 19; and

FIG. 21 is a sectional view of the catch plate assembly shown in FIG. 19.

### DETAILED DESCRIPTION OF THE PREFERRED EMBODIMENT(S)

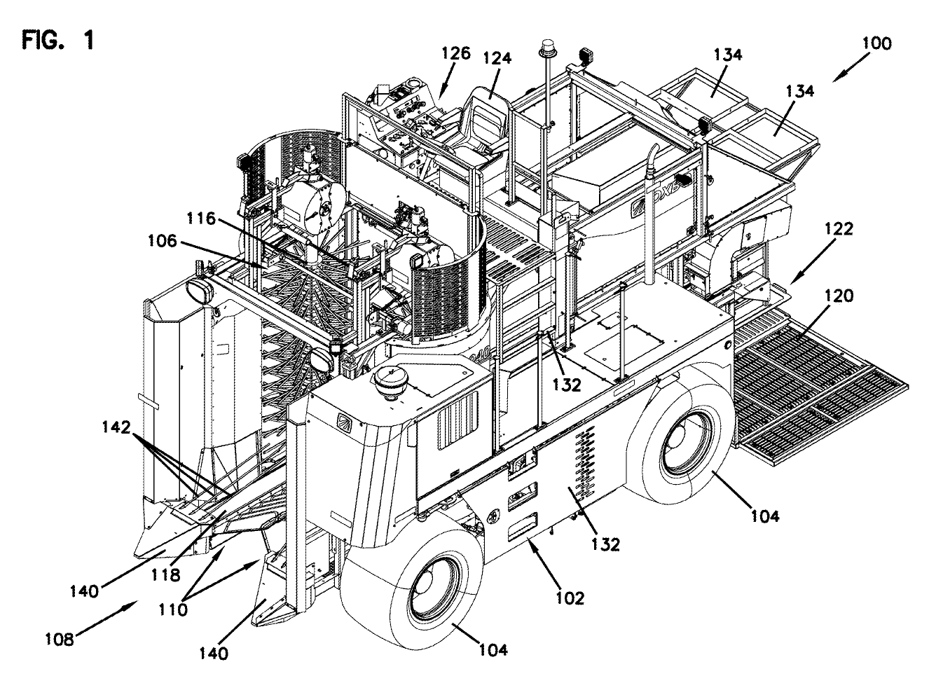

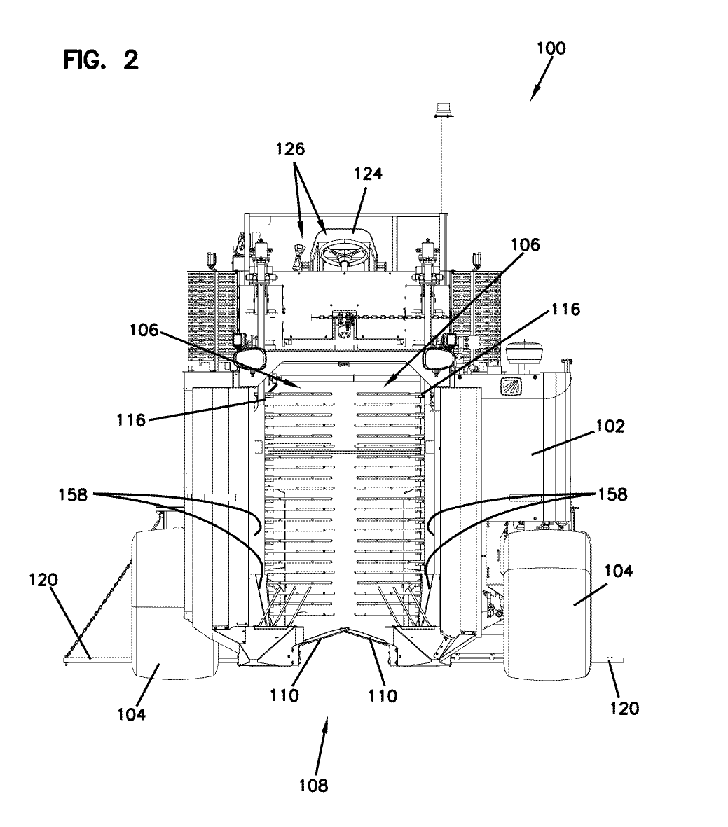

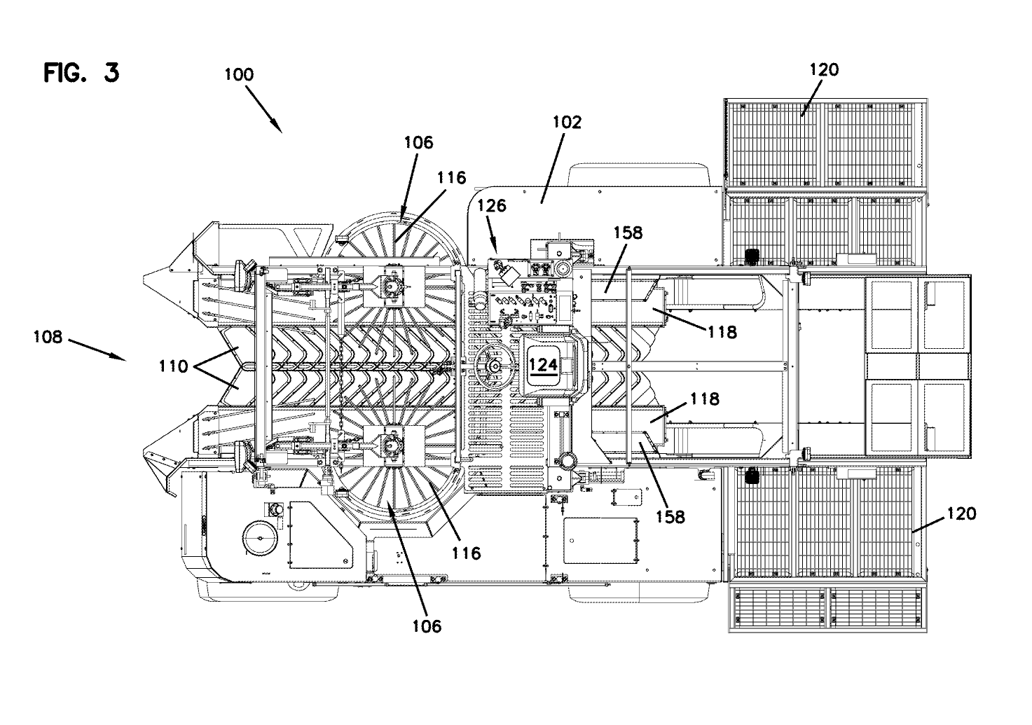

Referring now to the drawings and in particular to FIGS. 1-6, there is shown a berry harvester, generally designated (100). The berry harvester may be an over the row type harvester with a chassis (102) forming a picking tunnel (108), such as shown for example in FIG. 2. The chassis is supported on wheels (104). The harvester (100) may include three wheels as shown or also four wheels, depending upon the application and requirements for its use. The harvester (100) includes a driver's seat (124) at an upper front portion of the harvester (100). Controls (126) such as switches, a joystick and a steering wheel are easily accessible from the driver's seat (124).

The harvester (100) includes ladders (132) to access various areas on the machine. Racks (134) provide for storing containers to be filled with berries. Decks (120) are typically at the rear of the machine and provide an area for workers to fill containers at a filling station (122) at each side of the harvester (100). The decks (120) may fold or include portions that fold to decrease the width of the harvester (100) for transport or storage.

In the embodiment shown, the harvester includes a picking assembly (106) with rotary picking heads (116) having orbital shaking picking battens. The battens project radially and extend into the plants to agitate the berry bushes as well as rotating and moving in an orbital type motion. It has been found that such agitation/engagement with the plants is effective in removing ripe berries. It can be appreciated however that the present invention is also adaptable to harvesters with other types of picking systems such as rotary picking heads with horizontal shaking battens or sway shakers. The picking assembly (106) is generally configured with the rotary picking heads opposed on either side of the picking tunnel (108). As the harvester (100) advances along the row of plants, the plants pass through and along the tunnel (108) and are engaged by the picking assembly (106) to remove the ripe berries.

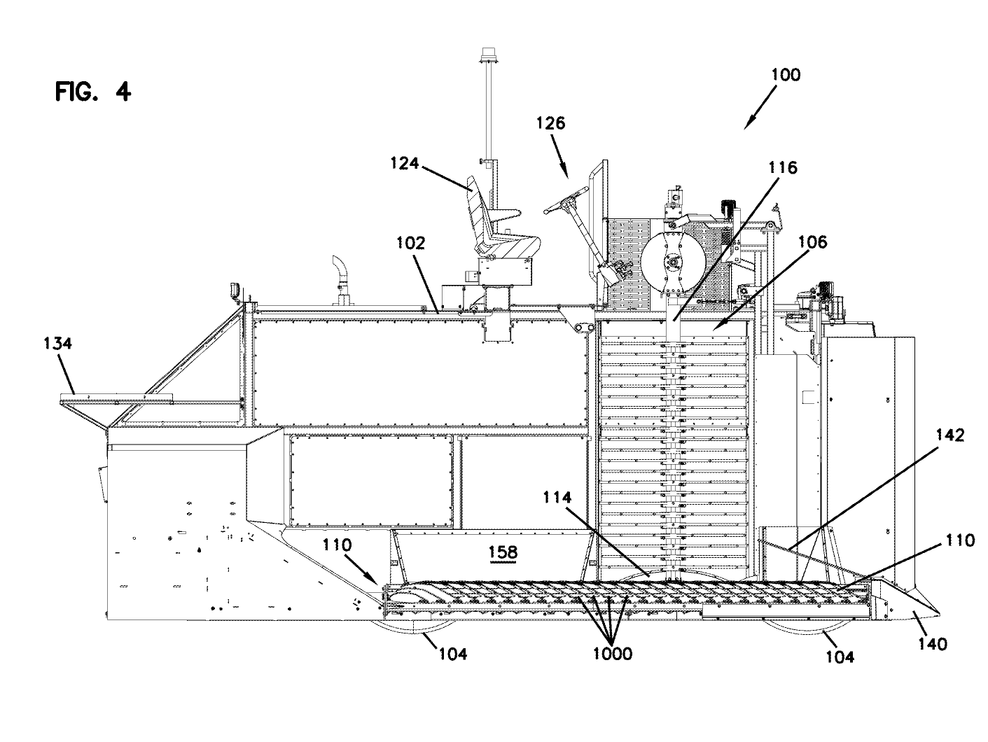

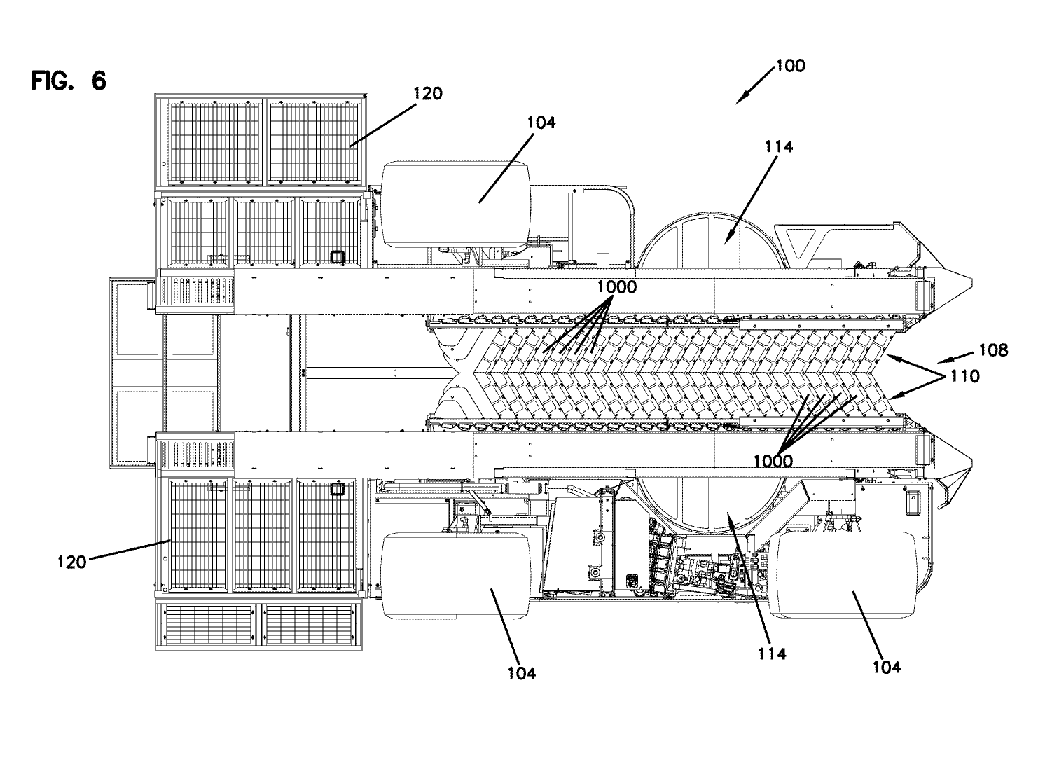

Forward of the picking tunnel (108), low profile nose cones (140) provide a transitional surface to help to guide the fruiting canes or branches into the harvester tunnel (108). Moreover, cane lifters (142) aid in positioning lower branches of plants and lift them to be engaged by the orbital picking heads (116) for more efficient plant engagement. The fruit removed by the picking assembly (106) falls onto a catching system (110). As shown, for example in FIG. 6, the catching system (110) includes an opposed line of overlapping catch plate assemblies, such as catch plate assemblies (1000), mounted on each side of the tunnel (108). The catch plate assemblies (1000) extend generally toward the center of the picking tunnel (108). The catch plate assemblies (1000) are generally configured as some planar catch plates that pivotally mount and are biased toward the extended positions, as shown in FIGS. 4-6. However, the rotational mounting allows the plate assemblies to rotate or pivot backward and inward to follow around the crown of the berry bushes as the harvester (100) advances. The catch plates (1000) generally pivot out of the way when engaging the crown and then are biased back to their overlapping position. The catch plate assemblies (1000) extend inward from a lower portion at each side of the picking tunnel (108) and are also angled slightly upward toward the center of the tunnel (108), forming a peak where the ends of the plates overlap in the center of the tunnel. With an upper slightly sloped surface, fruit that falls onto the catch plate assemblies (1000) rolls outward in the tunnel onto conveyors (118). The conveyors then transport the fruit to the filling station (122). In some embodiments, the harvester (100) may include additional conveyors or may include fans and/or a cleaning station to remove debris away from the harvested berries.

As shown most clearly in FIGS. 2, 4 and 5, the picking tunnel (108) includes surfaces (158) and (114) that are composed of a soft cushioning material such as neoprene. The soft padded surfaces therefore provide a soft engagement surface (158) for fruit that is flung against the surfaces. The soft neoprene surfaces (158) reduce the impact from the fruit engaging the surfaces and therefore reduce bruising of the fruit. By minimizing bruising, the quality of the berries harvested with such a mechanical harvester (100) may be marketed as fresh fruit.

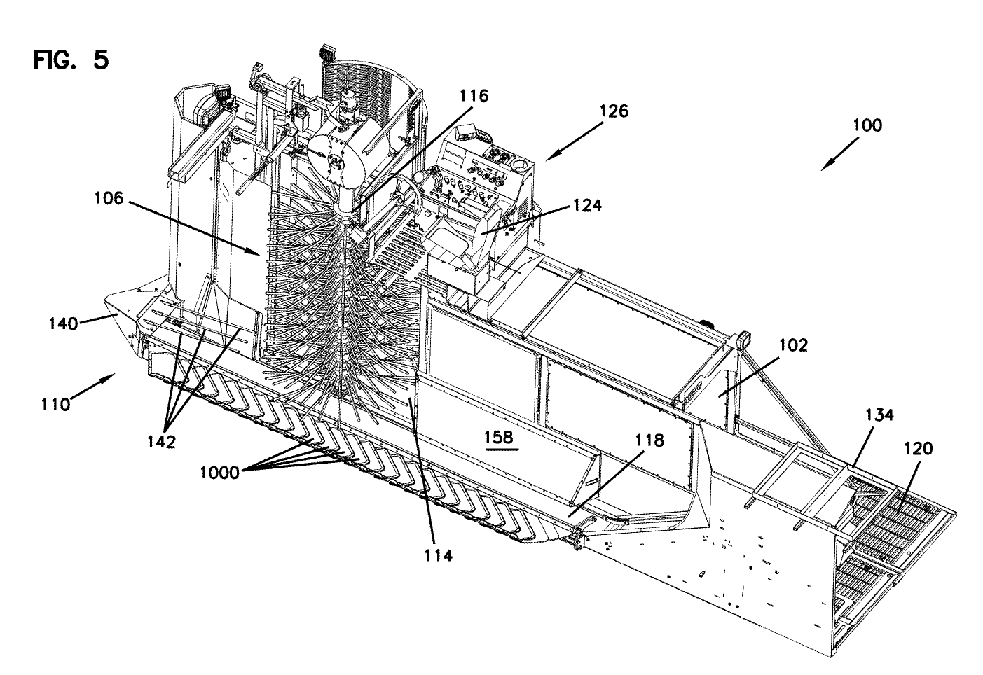

In addition to the hardness of the surface engaged by the fruit, creating an oblique angle at impact may also lessen the force from the fruit striking surfaces. As shown, for example, in FIGS. 4 and 5, the lower portion of the picking tunnel is a sloped surface (158). The upper surfaces (158) provide a degree of resiliency or elasticity and absorb some of the force of the impact. The soft surface combined with slanting of the surface reduce or eliminate bruising to the berries due to impact after being dislodged from the bushes and falling.

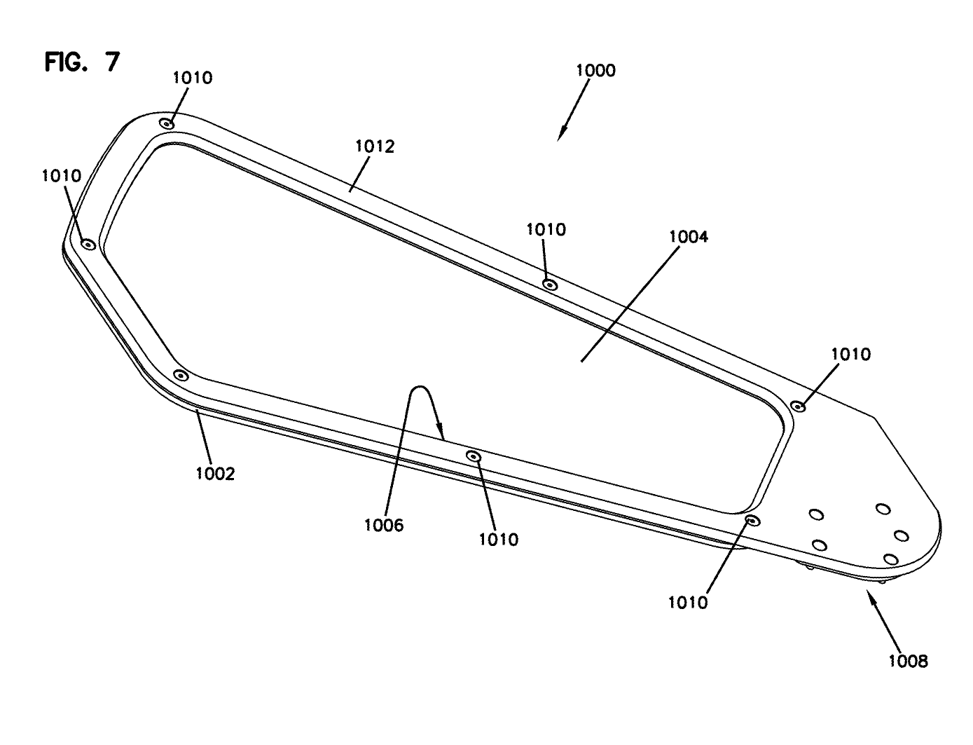

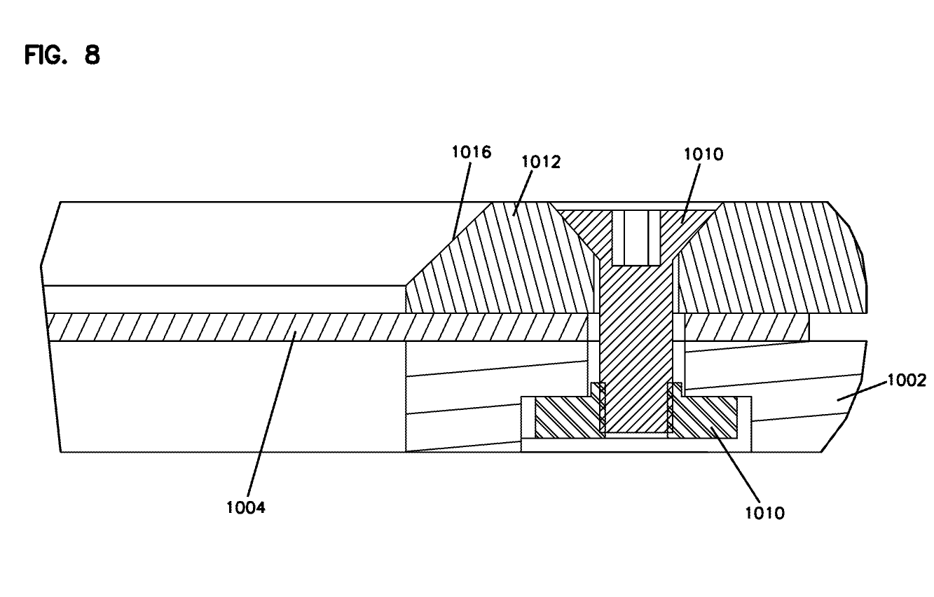

It can further be appreciated that the catch plate assemblies (1000) for the catching system (110) also may include upper surfaces that lessen the impact and therefore the damage to the fruit. As shown in FIGS. 7 and 8, a first embodiment of the catch plate assembly (1000) includes a frame (1002) and a flexible trampoline type sheet (1004) stretched across the frame in a trampoline like arrangement. The frame (1002) defines central openings (1006) and connects to a retainer (1012), such as a ring that provides clamping the sheet (1004). The frame (1002) and retainer (1012) may be made of lightweight materials such as nylon or polycarbonate. The catch plate assembly (1000) also includes a pivotal mount (1008) allowing the assemblies to rotate, as occurs when engaging the crown of a plant. It can be appreciated that the upper surface of the catch plate assembly is slightly skewed from perpendicular to the axis of the mounting portion (1008) so that the catch plate assemblies (1000) form upper surfaces with a slight slope that facilitates fruit rolling onto the conveyors. Moreover, the catching plate assemblies (1000) are configured so that they may slightly nest adjacent assemblies and overlap one another, both along the center line and from front to rear over adjacent catching assemblies, as shown for example in FIGS. 4 and 5.

As shown in FIGS. 7 and 8, the frame (1002) and retainer (1012) are attached by mounting hardware (1010) such as screws or bolts. The retainer (1012) has chamfered edges (1016) around the openings (1006) in the embodiment shown. The center openings (1006) allow the sheet to act as a trampoline and flex slightly when struck by falling fruit. The sheet (1004) acts as a trampoline is formed of a stretchable resilient material such as neoprene. The sheet mounting arrangement provides for resiliency of the sheet (1004) to minimize damage and bruising from impact from fruit. The trampoline like sheet (1004) is unsupported away from the edges and is able to deflect and stretch from the fruit to absorb some of the kinetic energy of the falling fruit and decrease the impact from falling onto the catch plates (1000). However, the sheet (1004) is preferably mounted to provide a receiving surface that has sufficient resiliency and tautness to allow fruit to roll off the catch plate assemblies (1000) to the conveyors. It can be appreciated that the shape may be varied somewhat as long as the upper surface absorbs some of the energy of the fruit lessens the damage from impact and provides overlap and directs fruit toward the conveyors. Moreover, having each sheet (1004) clamped at its edges allows the sheet to deflect and also to minimize tearing. The sheets (1004) are easily replaced if torn or permanently stretched by separating the frame (1002) and retainer (1012) and inserting a new sheet (1004).

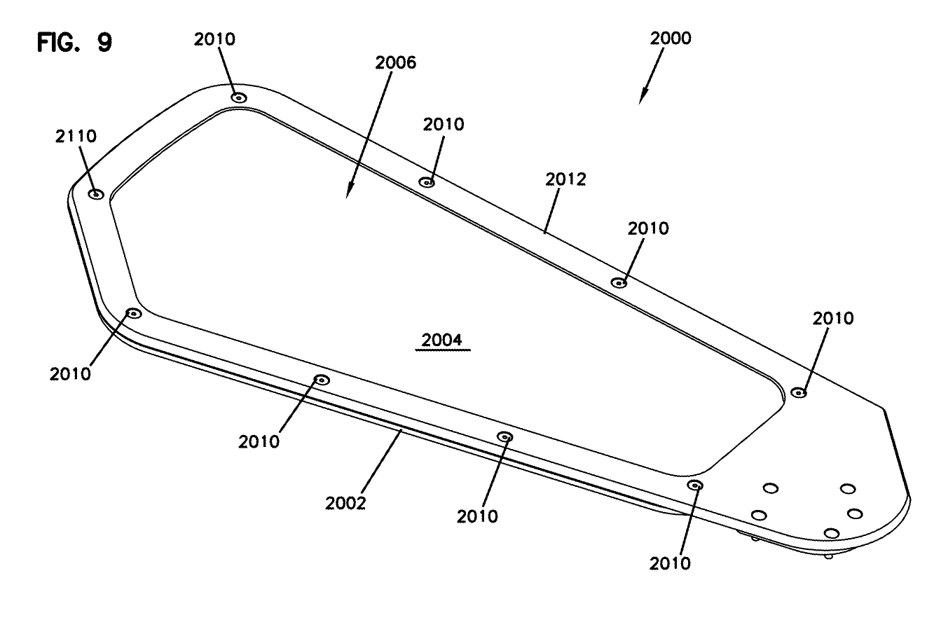

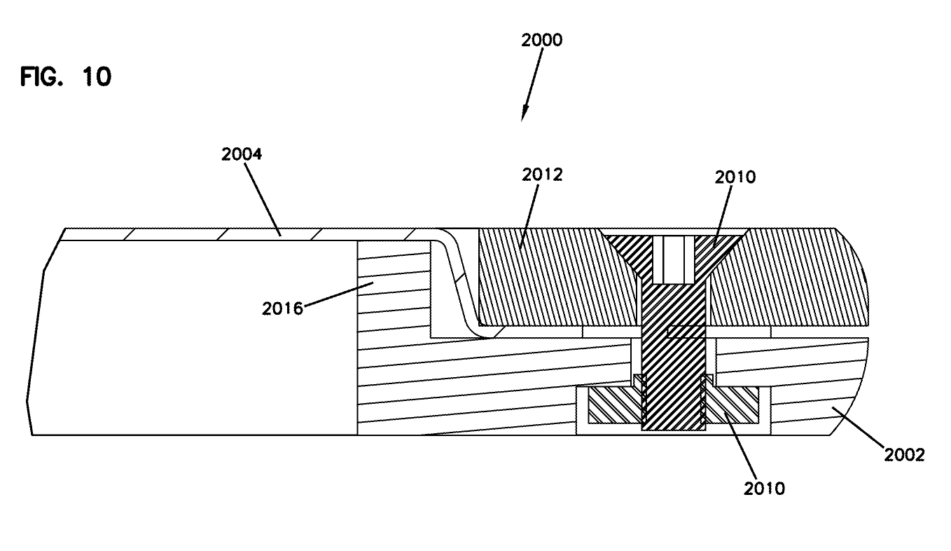

Referring now to FIGS. 9 and 10, there is shown a second embodiment of a catch plate assembly, generally designated (2000). The catch plate assembly (2000) is similar to the catch plate assembly (1000). The assembly has a retainer (2012) mounted to a frame (2002) with hardware (2010 and forms an opening (2006). However, the assembly (2000) has a slightly different mounting arrangement as shown in FIG. 10. The frame (2002) includes a lip (2016) over which a trampoline sheet (2004) is stretched so that the sheet (2004) is flush with a retainer (2012) as opposed to the chamfered configuration shown in FIG. 8.

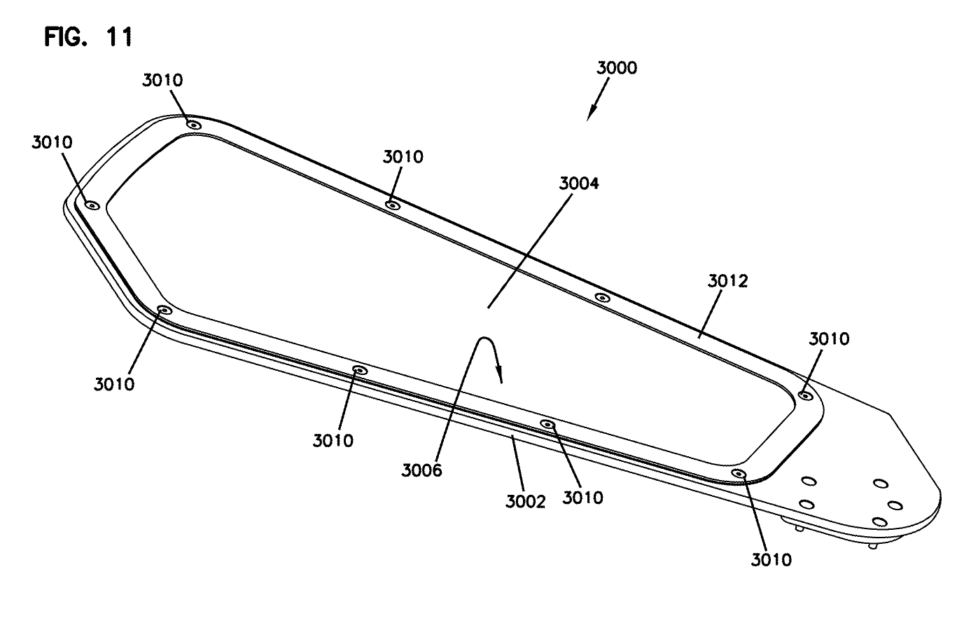

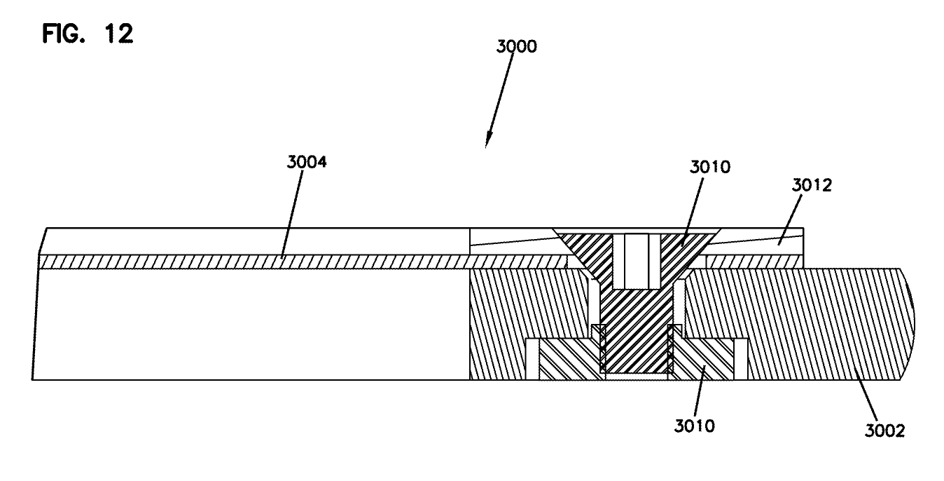

Referring to FIGS. 11 and 12, there is shown a third embodiment of a catch plate assembly, generally designated (3000). The catch plate assembly (3000) again includes a trampoline sheet (3004) that is stretched and held by a frame (3002) and retainer (3012) connected by hardware (3010). In the embodiment shown in FIGS. 11 and 12, the retainer (3012) is substantially thinner than in the other embodiments. The thinner retainer (3012) is therefore able to achieve satisfactory performance without a chamfer. Although not needed, a chamfer may be incorporated into the retainer (3012). A center opening (3006) allows the sheet (3004) to deflect when impacted. As shown in FIG. 12, the mounting arrangement has the retainer (3012) recessed from an edge of the frame (3002) sandwiching the trampoline sheet (3004). The catch plate elements (3002, 3010 and 3012) may be made of nylon, polycarbonate, stainless steel or other appropriate materials.

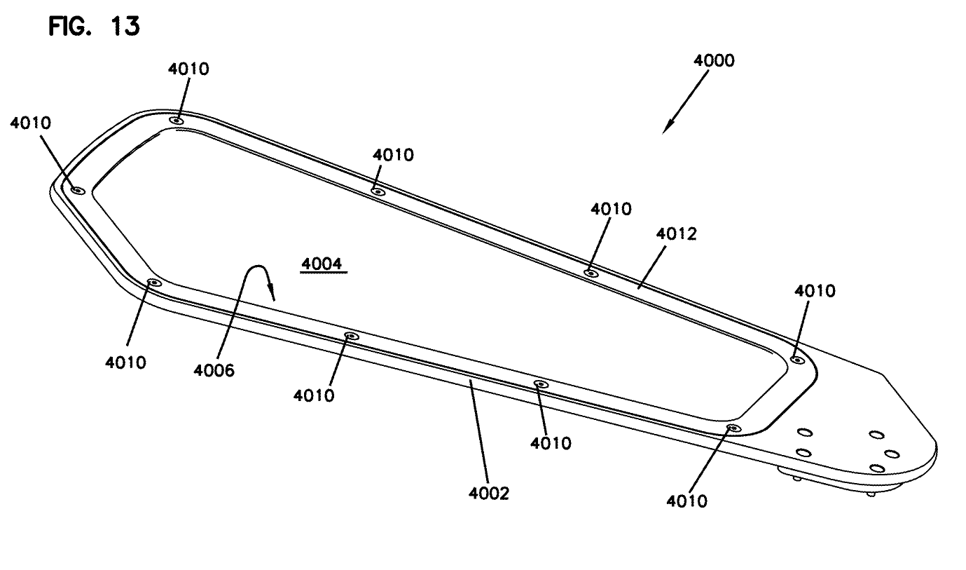

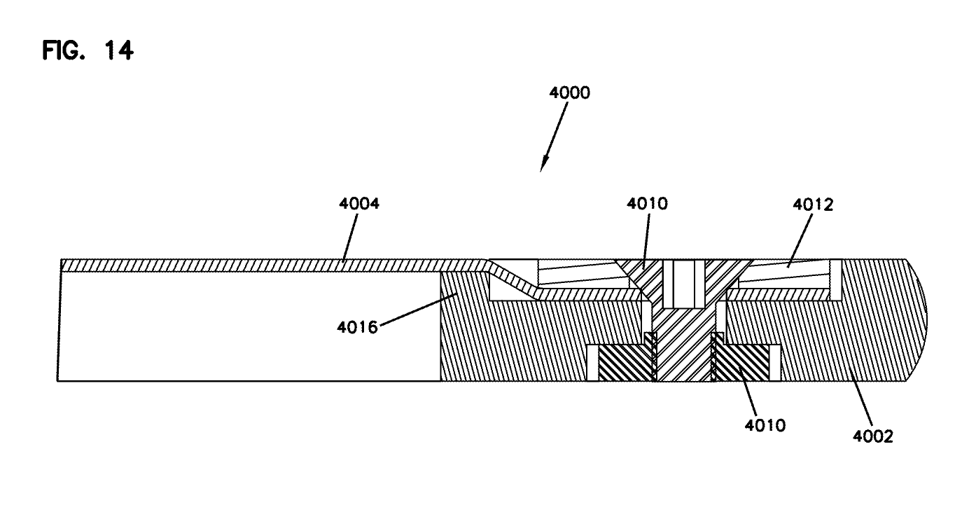

Referring now to FIGS. 13-14, there is shown a fourth embodiment if a catch plate assembly, generally designated (4000). It may be appreciated that the catch plate assembly (4000) includes a trampoline sheet (4004), a frame (4002) with a retainer element (4012) connected to the frame (4002) by hardware (4010). The frame (4002) defines a center opening (4006) to allow the sheet to deflect. The material of the sheet (4004) is again stretched and held by mounting elements (4012) and stretched over a lip (4016). Moreover, it can be appreciated that the materials might be formed of nylon, polycarbonate, stainless steel or other appropriate materials. It can further be appreciated that the frame (4002) and the retainer (4012) may be configured for snap engagement rather than using mounting hardware.

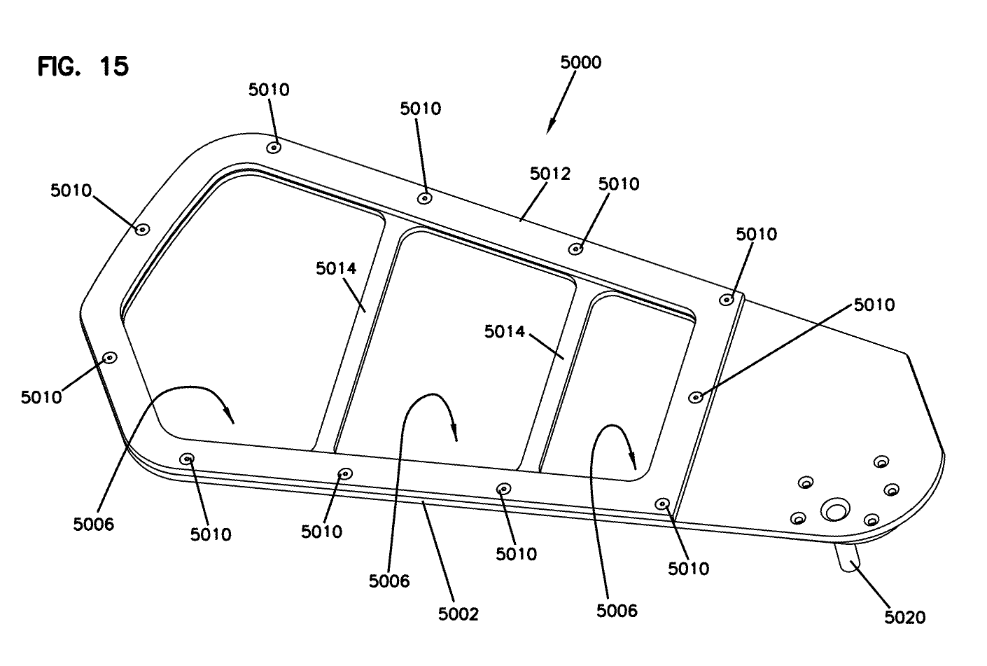

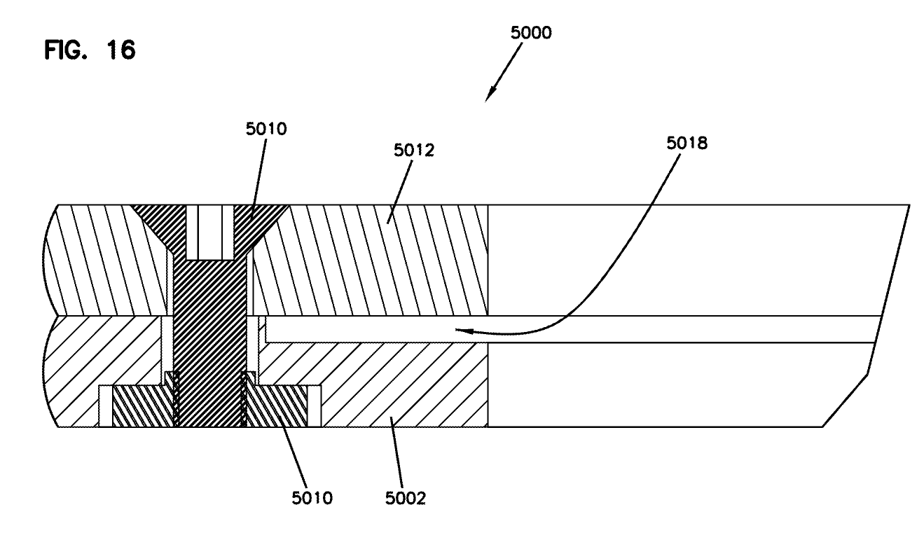

Referring now to FIGS. 15 and 16, there is shown a further embodiment of a catch plate assembly, generally designated (5000). In the embodiment shown, the frame (5002) connects to a retainer (5012) with hardware (5010) in a manner similar to other embodiments. However, the frame (5002) includes two ribs (5014) that define three separate openings (5006). It is also appreciated that other rib configurations are possible with different numbers and shapes of ribs and openings. As shown in FIG. 16, the mounting arrangement includes a pocket (5018) for neoprene material of the trampoline sheet (5004). The retainer (5012) clamps against the sheet (5004) to clamp the sheet into the pocket (5018). A pin (5020) allows the catch plate assembly (5000) to be rotationally mounted.

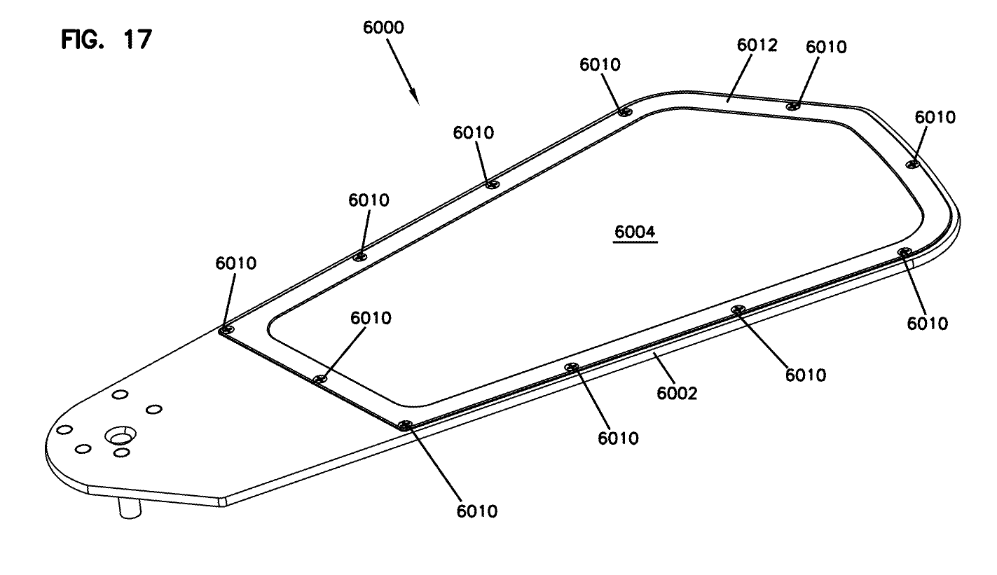

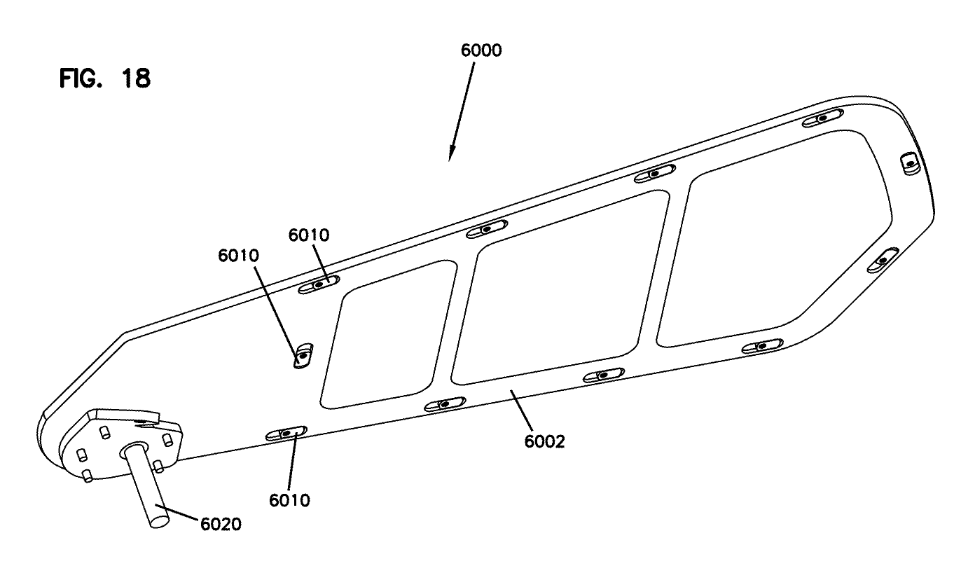

Referring now to FIGS. 17 and 18, there is shown a sixth embodiment of a catch plate assembly, generally designated (6000). The catch plate assembly (6000) includes a frame (6002) with a stretched trampoline sheet (6004) in a manner similar to the catch plate assembly (3000). In the embodiment shown in FIGS. 17 and 18, the frame (6002) includes ribs (6014) that define three openings (6006) and support the back of the trampoline sheet (6004). It is also appreciated that other rib configurations are possible with different numbers and shapes of ribs and openings. The catch plate assembly (6000) includes a top retainer (6012) connected to the frame (6002) with hardware (6010). The retainer clamps against the frame (6002) to sandwich and retain the sheet (6004). A pin (6020) provides for rotationally mounting the catch plate assembly (6000) and maintains an upper surface at the proper orientation. The frame (6000) may be made of a lightweight material such as Lexan and the retainer (6012) may be stainless steel.

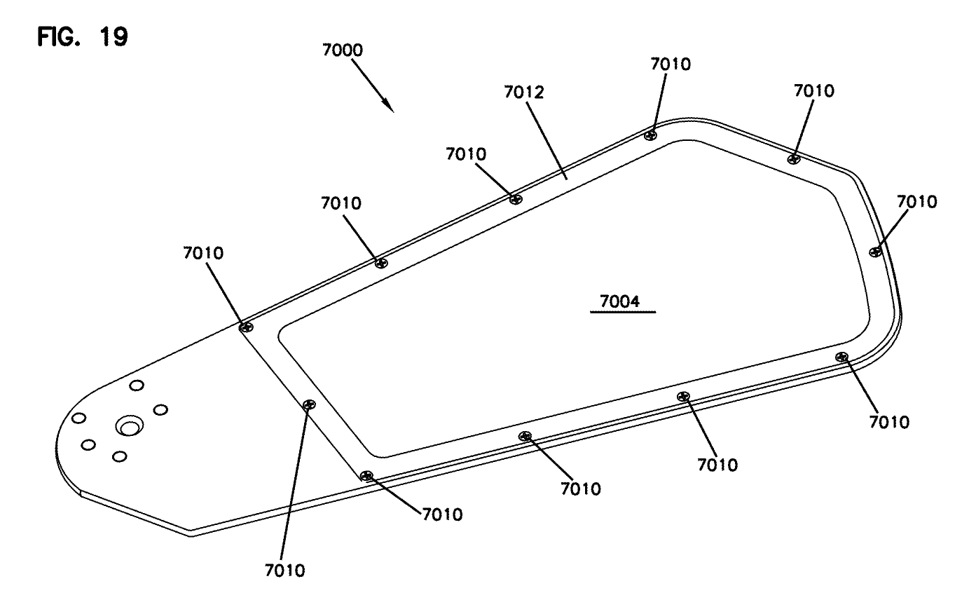

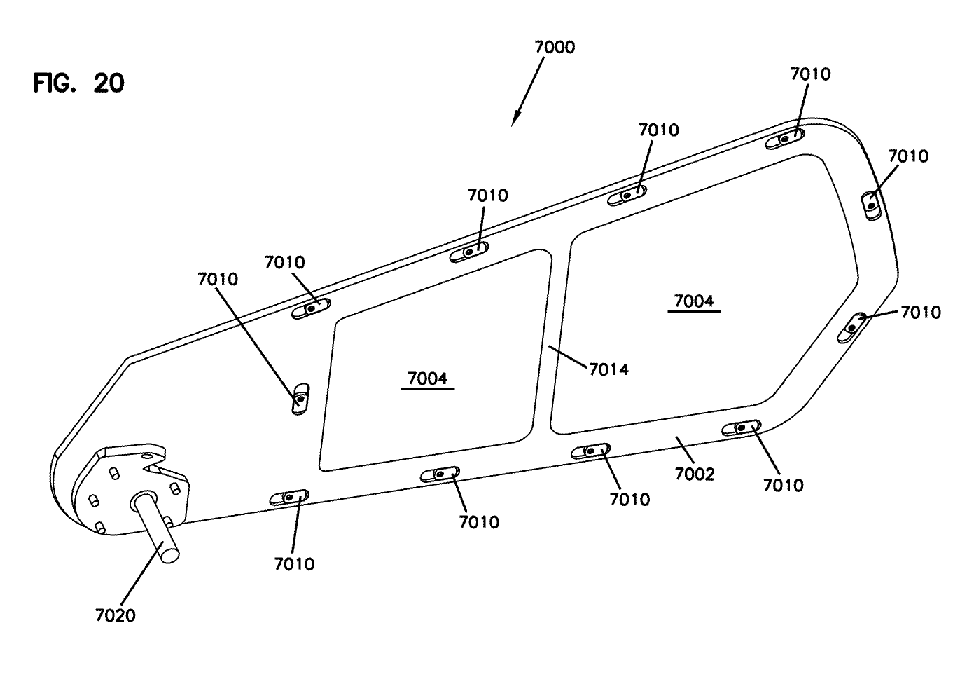

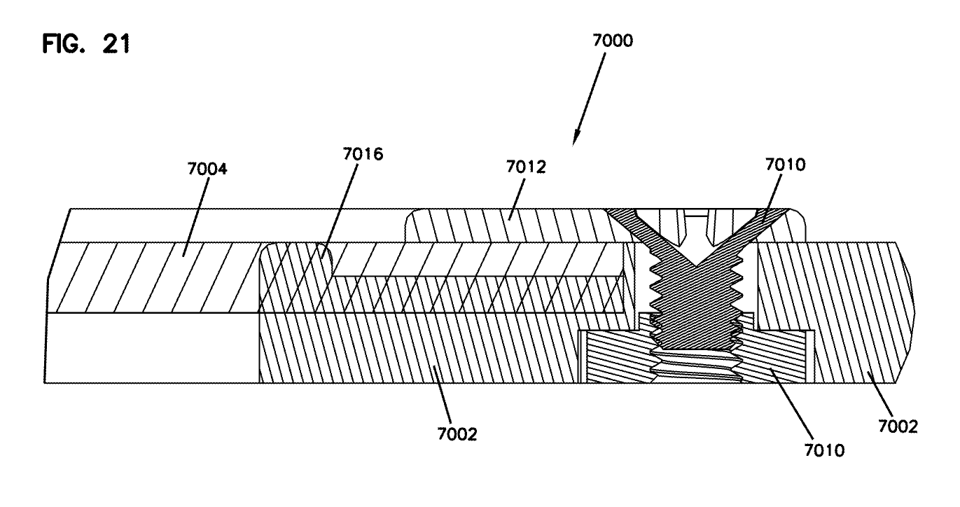

Finally, referring to FIGS. 19-21, there is shown a seventh embodiment of a catch plate assembly, generally designated (7000). The catch plate assembly includes a frame (7002) and a trampoline type sheet (7004) in a manner similar to the catch plate assembly (4000). The frame includes a rib (7014) that defines two openings (7006). It can be appreciated that other rib configurations are possible with different numbers and shapes of ribs and openings. The catch plate assembly (7000) and includes a stainless steel ring type retainer (7012) that attaches to the frame (7002) with hardware (7010). In the embodiment shown, the frame (7002) extends inward from the retainer (7012) and includes a bump (7016) over which the trampoline sheet (7004) is stretched. The ring and frame may define one or more openings (7006). A mounting pin (7020) mounts to the lower side of the frame and provides for rotation and positioning of the upper surface to facilitate fruit rolling from the catch plate assembly (7000).

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. An over the row fruit harvester, comprising:
a chassis defining a picking tunnel;
a picking system configured to remove fruit from plants;
a catching system configured to receive fruit removed from the plants;
the catching system comprising:
a plurality of resilient catch assemblies on each side of the picking tunnel, each of the catch assemblies at least partially overlapping adjacent catch assemblies, each of the catch assemblies having an upper surface oriented orthogonally to horizontal, the catch assemblies flexing upon impact by falling fruit.

2. A fruit harvester according to claim 1, wherein flexibility of the catching assemblies is adjustable.

3. A fruit harvester according to claim 1, wherein each catching assembly comprises a trampoline element.

4. A fruit harvester according to claim 1, wherein the catch assemblies are rotational mounted.

5. A fruit harvester according to claim 1, further comprising flexible cushioning on exposed surfaces of the picking tunnel.

6. A fruit harvester according to claim 5, further comprising angled receiving assemblies providing a sloped surface along sides of the picking tunnel for deflecting falling fruit.

7. A fruit harvester according to claim 1, further comprising angled receiving assemblies providing a sloped surface along sides of the picking tunnel for deflecting falling fruit.

8. An over the row fruit harvester, comprising:
a chassis defining a picking tunnel;
a picking system configured to remove fruit from plants;
a catching system configured to receive fruit removed from the plants;
the catching system comprising:
cushioning on exposed surfaces of the picking tunnel;
angled receiving assemblies providing a flexible sloped surface along sides of the picking tunnel for deflecting fall fruit.

9. A fruit harvester according to claim 8, wherein the harvester comprises an over the row harvester.

10. A fruit harvester according to claim 8, wherein flexibility of the angled receiving assemblies is adjustable.

11. A fruit harvester according to claim 8, wherein each of the angled receiving assemblies comprise an upper flexible trampoline element.

12. A fruit harvester according to claim 11, wherein the trampoline element comprises materials supported at opposed edges, wherein tautness of the trampoline element is adjusted by pulling on or releasing the trampoline element.

13. A fruit harvester according to claim 12, wherein at least one edge of the trampoline element is wound on a roller and rotation of the roller in a first direction tightens the trampoline element and rotation of the roller in a second direction opposite to the first direction loosens the trampoline element.

14. A fruit harvester according to claim 8, further comprising a plurality of resilient catch assemblies at a lower portion of the picking tunnel, each of the catch assemblies at least partially overlapping adjacent catch assemblies, each of the catch assemblies having an upper surface oriented orthogonally to horizontal, the catch assemblies flexing upon impact by falling fruit.

15. A catcher assembly comprising:
a planar framework forming a center opening;
a retainer attached to the framework;
a sheet clamped between the framework and the retainer and stretch across the center opening, the sheet being supported solely by the framework and retainer;
a rotary mount for the mounting the catching assembly.

16. A fruit catching system, for a harvester, the fruit catch system comprising:
a first row of overlapping catcher devices and a second row of overlapping catcher devices, the first row of overlapping catcher devices and the second row of overlapping catcher devices defining a passage for receiving plants to be harvested as the harvester travels; each of the catcher devices comprising:
a planar framework forming a center opening;
a retainer attached to the framework;
a sheet clamped between the framework and the retainer and stretch across the center opening, the sheet being supported solely by the framework and retainer; and
a rotary mount for the mounting the catching assembly.
